(19) United States
(12) Patent Application Publication
(10) Pub. No.: US 2011/0261100 A1
(43) Pub. Date: Oct. 27, 2011

(54) PRINTING DEVICE AND PRINTING METHOD

(75) Inventors: Takahide MIYASHITA, Shiojiri (JP); Bunji ISHIMOTO, Matsumoto (JP); Tatsuo FURUTA, Shiojiri (JP); Akito SATO, Matsumoto (JP)

(73) Assignee: SEIKO EPSON CORPORATION, Tokyo (JP)

(21) Appl. No.: 13/078,087

(22) Filed: Apr. 1, 2011

(30) Foreign Application Priority Data
Apr. 23, 2010 (JP) 2010-100007
May 13, 2010 (JP) 2010-110718

(51) Int. Cl. B41J 29/38

(52) U.S. Cl. 347/12

(57) ABSTRACT

A first pseudo band is printed, a second pseudo band is printed so as to partially overlap the first pseudo band, and the overlap printed area is divided by a single continuously boundary line into a first area first area printed by the first pseudo band, and a second area printed by the second pseudo band.

### CROSS-REFERENCE TO RELATED APPLICATIONS

This application claims priority to Japanese Patent Application No. 2010-100007 filed on Apr. 23, 2010 and Japanese Patent Application No. 2010-110718 filed on May 13, 2010. The entire disclosures of Japanese Patent Application Nos. 2010-100007 and 2010-110718 are hereby incorporated herein by reference.

### BACKGROUND

1. Technical Field

The present invention relates to a printing device and a printing method.

2. Related Art

Band printing with a plurality of nozzles is one technique used when executing printing by an inkjet system. There are devices that, when doing so, print adjacent bands such that the boundaries thereof partially overlap, in order to prevent white streaks or density irregularities at boundaries between bands (Japanese Laid-Open Patent Application Publication No. 8-244253, for example).

### SUMMARY

However, when the results are observed subsequent to printing, in some instances there are noticeable differences in color shading between printed portions in which bands overlap and printed portions with no overlap of bands.

It is accordingly an object of the present invention to address the above problem at least in part, and to prevent noticeable differences in color shading between portions printed with overlap of bands, and portions printed without overlap of band.

The present invention is directed to addressing the above problem at least in part through the following aspects.

A printing device according to a first aspect includes a print head having a plurality of nozzles, a main scanning direction drive mechanism configured and arranged to move the print head and a printing medium relative to each other in a main scanning direction, a sub-scanning direction drive mechanism configured and arranged to move the print head and the printing medium relative to each other in a sub-scanning direction, and a control portion. The control portion is configured to execute partial overlap printing whereby the print head and the printing medium are moved relative to each other in the sub-scanning direction in a single main scan pass so that pseudo bands are printed in the course of N (where N is a natural number) main scan passes, and an overlap printed area constituting portions of the pseudo bands is printed in the course of 2N main scanning passes. The overlap printed area is divided by a single continuous boundary line into a first area that is printed by upstream nozzles among the plurality of nozzles, and a second area that is printed by downstream nozzles among the plurality of nozzles. The boundary line includes a first boundary line portion where a parallel line extending parallel to the sub-scanning direction crosses over the boundary line from the first area into the second area, and a second boundary line portion where the parallel line crosses over from the second area into the first area.

According to this aspect, because the boundary line is a boundary line that includes a first boundary line portion where the parallel line crosses over the boundary line from the first area into the second area, and a second boundary line portion where the parallel line crosses over from the second area into the first area, if in one of the boundary line portions, the first area and the second area extend in a direction such that a space therebetween is not printed, in the other boundary line portion, the first area and the second area will lie in the direction of overlap. As a result, it is possible to avoid noticeable differences in color shading between printed portions in which bands overlap and printed portions with no overlap of bands.

A printing device according to a second aspect is the printing device according to the first aspect, wherein the boundary line preferably has asperities with a low-frequency component and a high-frequency component with respect to the main scanning direction. According to this aspect, it is possible for the high-frequency component to disperse continuity of the low-frequency component in the main scanning direction or a direction diagonal to the sub-scanning direction.

A printing device according to a third aspect is the printing device according to the second aspect, wherein an amplitude of the high-frequency component of the asperities is preferably smaller than an amplitude of the low-frequency component.

A printing device according to a fourth aspect is the printing device according to any of the first to third aspects, wherein the boundary line is preferably formed along a contour of a polygonal shape that is formed by a combination of a first triangle having a base side parallel to the main scanning direction, and a second triangle smaller than the first triangle and having as a base side a portion of an oblique side of the first triangle.

According to this aspect, it is possible for the second triangles to disperse continuity of the first triangles in the main scanning direction or a direction diagonal to the sub-scanning direction.

A printing device according to a fifth aspect is the printing device according to the fourth aspect, wherein one of two oblique sides of the second triangle preferably intersects the main scanning direction at an angle of more than 0 degree and less than 45 degrees, while the other of the two oblique sides preferably intersects the main scanning direction at an angle of more than 45 degrees and less than 90 degrees.

According to this aspect, streaks are unlikely to appear in the main scanning direction or in the sub-scanning direction.

A printing device according to a sixth aspect is the printing device according to the first aspect, wherein the boundary line preferably includes a Koch curve portion or a fractal shape portion.

According to this aspect, because the Koch curve portion or the fractal shape has self-similarity, it is possible to disperse gaps and overlap between the first area and the second area.

A printing device according to a seventh aspect is the printing device according to any of the first to sixth aspects, wherein the boundary line preferably includes a portion where a second parallel line extending parallel to the main scanning direction crosses over the boundary line from the first area into the second area, and a second boundary line portion where the second parallel line crosses over from the second area into the first area.

According to this aspect, it is possible to avoid noticeable differences in color shading between printed portions in which bands overlap and printed portions with no overlap of bands, even if the first area and the second area further deviate in the main scanning direction.

A printing device according to an eighth aspect includes a print head having a plurality of nozzles, a main scanning direction drive mechanism configured and arranged to move the print head and a printing medium relative to each other in a main scanning direction during band printing, a sub-scanning direction drive mechanism configured and arranged to move the print head and the printing medium relative to each other in a sub-scanning direction, and a control portion. The control portion is configured to execute partial overlap printing whereby the print head and the printing medium are moved relative to each other in the sub-scanning direction in a single main scan pass so that pseudo bands are printed in the course of N (where N is a natural number) main scan passes, and an overlap printed area constituting portions of the pseudo bands is printed in the course of 2N main scanning passes. The overlap printed area is divided by a single continuous boundary line into a first area that is printed by upstream nozzles among the plurality of nozzles, and a second area that is printed by downstream nozzles among the plurality of nozzles. The boundary line includes a first boundary line portion where a parallel line extending parallel to the main scanning direction crosses over the boundary line from the first area into the second area, and a second boundary line portion where the parallel line crosses over from the second area into the first area.

According to this aspect, it is possible to avoid noticeable differences in color shading between printed portions in which bands overlap and printed portions with no overlap of bands, even if the first area and the second area deviate in the main scanning direction.

A printing method according to a ninth aspect includes: moving a print head and a printing medium relative to each other in a sub-scanning direction in a single main scan pass so that a first pseudo band is printed in the course of N (where N is a natural number) main scan passes; and moving the print head and the printing medium relative to each other in the sub-scanning direction in a single main scan pass so that a second pseudo band is printed in the course of N main scan passes so as to partially overlap the first pseudo band to form an overlap printed area. The overlap printed area is divided by a single continuous boundary line into a first area printed by the first pseudo band, and a second area printed by the second pseudo band. The boundary line includes a first boundary line portion where a parallel line extending parallel to the sub-scanning direction crosses over the boundary line from the first area into the second area, and a second boundary line portion where the parallel line crosses over from the second area into the first area.

The present invention may be embodied in various other aspects besides a printing device; for example, a printing method, a band mask, or the like.

### BRIEF DESCRIPTION OF THE DRAWINGS

Referring now to the attached drawings which form a part of this original disclosure:

FIG. 1 is a drawing showing a configuration of a printing system.

FIG. 2 is a drawing showing a nozzle row of a print head.

FIGS. 3A and 3B are drawings showing partial overlap printing.

FIG. 4 is a drawing showing an enlarged section of FIG. 3B.

FIG. 5 is a drawing showing pixel rows in a portion printed by upstream nozzles and in a portion printed by downstream nozzles in an area P103.

FIG. 6 is a drawing showing instances of deviation of bands in the sub-scanning direction for a first band and a second band.

FIG. 7 is a drawing showing instances of deviation of bands in the main scanning direction of bands for a first band and a second band.

FIG. 8 is a drawing showing enlarged views of the vicinity of the boundary of line segments 110d, 110e.

FIGS. 9A and 9B are drawings showing features of a boundary line on a printing medium.

FIG. 10 is a drawing showing a modified example of a boundary line.

FIGS. 11A to 11D are drawings showing modified examples of boundary lines.

FIGS. 12A to 12C are drawings showing modified examples of boundary lines.

FIG. 13 is a drawing showing an example of an instance of using the Koch curve to form a portion printed by upstream nozzles and a portion printed by downstream nozzles.

FIG. 14 is a drawing showing other modified examples of boundary lines.

FIGS. 15A and 15B are drawings showing other modified examples of boundary lines.

FIGS. 16A and 16B are drawings showing in model form examples of pseudo band printing.

### DETAILED DESCRIPTION OF EXEMPLARY EMBODIMENTS

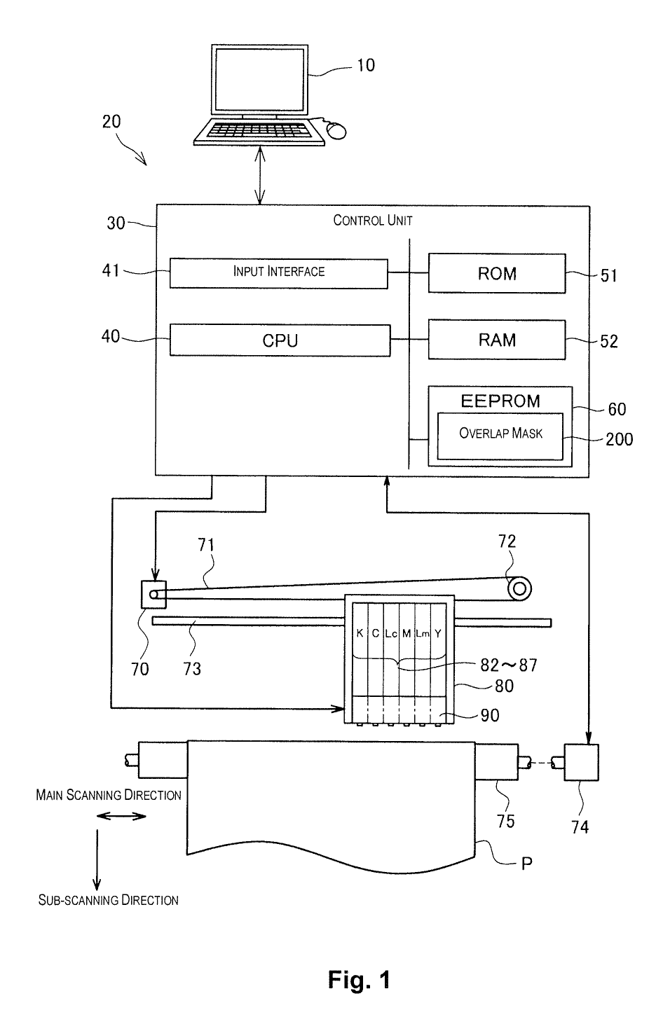

FIG. 1 is a drawing showing a configuration of a printing system. The printing system includes a computer 10 and a printer 20. The computer 10 generates print data for the printer 20, and sends it to the printer 20. The printer 20 is a serial inkjet printer, and includes a control unit 30, a carriage motor 70, a drive belt 71, a pulley 72, a slide rail 73, a paper feed motor 74, a paper feed roller 75, a carriage 80, ink cartridges 82 to 87, and a print head 90.

The control unit 30 includes a CPU 40, an input interface 41, a ROM 51, a RAM 52, and an EEPROM 60. Optionally, the control unit 30 may employ flash memory instead of the EEPROM 60. The EEPROM 60 stores a partial overlap mask 200. The CPU 40 loads into the RAM 52 a program that is stored in the ROM 51 or in the EEPROM 60, and executes the program to control general operation of the printer 20. The input interface 41 receives print data from the computer 10.

The drive belt 71 stretches between the carriage motor 70 and the pulley 72. A carriage 80 is mounted on the drive belt 71. On the carriage 80 there are installed ink cartridges 82 to 87 for colored inks, which respectively contain as color inks cyan ink (C), magenta ink (M), yellow ink (Y), black ink (K), light cyan ink (Lc), and light magenta ink (Lm). On a print head 90 at the bottom of the carriage 80 there are formed nozzle rows that correspond to the color inks of the colors mentioned above. With these ink cartridges 82 to 87 installed from above into the carriage 80, it is possible to supply ink to the print head 90 from the cartridges. The slide rail 73 is disposed parallel to the drive belt, and passes through the carriage 80.

As the carriage motor 70 drives the drive belt 71, the carriage 80 moves along the slide rail 73. This direction is referred to as the “main scanning direction.” In association with the movement of the carriage 80 in the main scanning direction, the ink cartridges 82 to 87 and the print head 90 also move in the main scanning direction. During movement in this main scanning direction, printing onto a printing medium P is carried out by ejecting the ink inside the ink cartridges 82 to 87 onto the printing medium P from print nozzles (described below) arranged on the print head 90. A single main scan is termed a “pass.”

The paper feed roller 75 is connected to the paper feed motor 74. During printing, the printing medium P is passed over the top of the paper feed roller 75. As the carriage 80 moves to the end position in the main scanning direction, the control unit 30 rotates the paper feed motor 74. By so doing, the paper feed roller 75 rotates as well, causing the printing medium P to move. The direction of this relative motion of the printing medium P and the print head 90 is termed the “sub-scanning direction.”

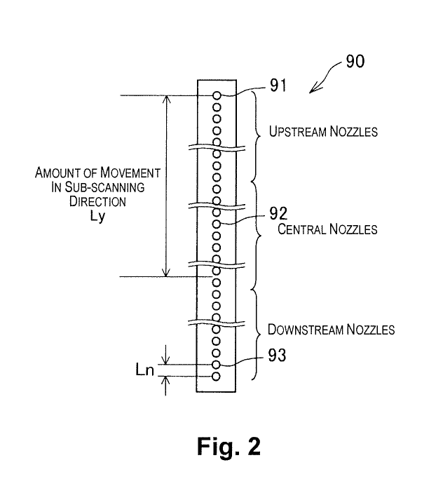

FIG. 2 is a drawing showing a nozzle row of a print head. The nozzle row shown in FIG. 2 is for a single color. In the present embodiment, because there are six colors, the printer 20 is provided with a nozzle row like that shown in FIG. 2 for each color row, for a total of six rows. The nozzle row has a plurality of upstream nozzles 91, a plurality of central nozzles 92, and a plurality of downstream nozzles 93. The upstream nozzles 91 and the downstream nozzles 93 are nozzle groups that are used during overlap printing, and have the same number of nozzles. The nozzle pitch Ln of the nozzles 91 to 93 is equal to twice the pitch of the pixel rows during printing. The amount of movement Ly of the printing medium P in the sub-scanning direction is a length equal to the sum of the length of Ln/2, the length of the portion of the upstream nozzles 91, and the length of the portion of the central nozzles 92, minus half the nozzle pitch (Ln/2).

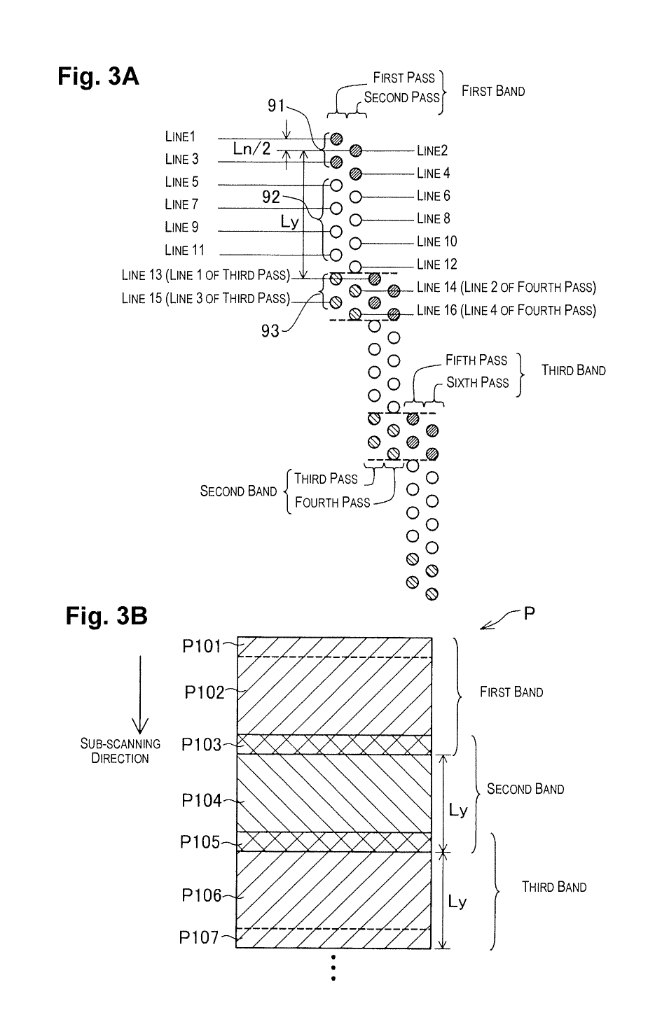

FIGS. 3A and 3B are drawings showing partial overlap printing. FIG. 3A depicts how printing is carried out in a sequence of passes by the nozzles 91 to 93 shown in FIG. 2; FIG. 3A illustrates an arrangement having two upstream nozzles 91, four central nozzles 92, and two downstream nozzles 93. In the first pass, the eight nozzles 91 to 93 print lines 1, 3, 5, 7, 9, 11, 13, and 15 (the odd-numbered lines). After printing of the first pass, the control portion 30 moves the printing medium P by a distance Ln/2 in the sub-scanning direction relative to the print head 90. Then, in the second pass, the eight nozzles 91 to 93 print lines 2, 4, 6, 8, 10, 12, 14, and 16 (the even-numbered lines). In the present embodiment, the area that is printed in this second pass is termed a “pseudo band” or simply a “band.” Here, “line n” indicates the “n-th” line within a single band.

Once printing of the second pass by the eight nozzles 91 to 93 is finished, the control portion 30 moves the printing medium P by a distance Ly in the sub-scanning direction relative to the print head 90. Then, a third pass is printed in the same manner as the first pass. At this time, lines 1 and 3 of the third pass are respectively the same as lines 13 and 15 of the first pass. The eight nozzles 91 to 93 then print a fourth pass in the same manner as the first pass. At this time, lines 2 and 4 of the fourth pass are respectively the same as lines 14 and 16 of the second pass. The eight nozzles 91 to 93 then print a fifth, sixth, and subsequent passes in the same manner.

FIG. 3B depicts printing of bands onto the printing medium P. The printing medium P is printed with areas P101 to P103 in the first band. Here, the area P101 is an area that is printed by the upstream nozzles 91, the area P102 is an area that is printed by the central nozzles 92, and the area P103 is an area that is printed by the downstream nozzles 93. The printing medium P is printed with areas P103 to P105 in the second band. In the second band, the area P103 is an area that is printed by the upstream nozzles 91, the area P104 is an area that is printed by the central nozzles 92, and the area P105 is an area that is printed by the downstream nozzles 93. Specifically, a portion of the area P103 is printed by the downstream nozzles 93 during printing of the first band, and the remaining portion is printed by the upstream nozzles 91 during printing of the second band. On the other hand, the area P102 and the area P104 are printed by the central nozzles 92 exclusively. Moving the printing medium P or the print head in the sub-scanning direction and printing successive bands, doing so with partial overlap within ranges in the sub-scanning direction in this manner, is called “partial overlap printing,” and an area that is printed in the course of multiple passes is termed an “overlap area.” For example, the areas P103 to P105 correspond to a single “band,” while the areas P103 and P105 respectively correspond to “overlap areas.” Similarly, as the third band, the areas P105 to P107 are printed and the area P105 is printed with overlap; and in the fourth band (not shown), the area P107 is printed with overlap. Areas printed by the upstream nozzles 91 and the downstream nozzles are printed in the two bands (four passes), while areas printed by the central nozzles 92 are printed in one band (two passes). However, the area that is printed by the upstream nozzles 91 during initial band printing onto the printing medium P and the area printed by the downstream nozzles during final band printing are printed by single iteration of band printing (two passes) only.

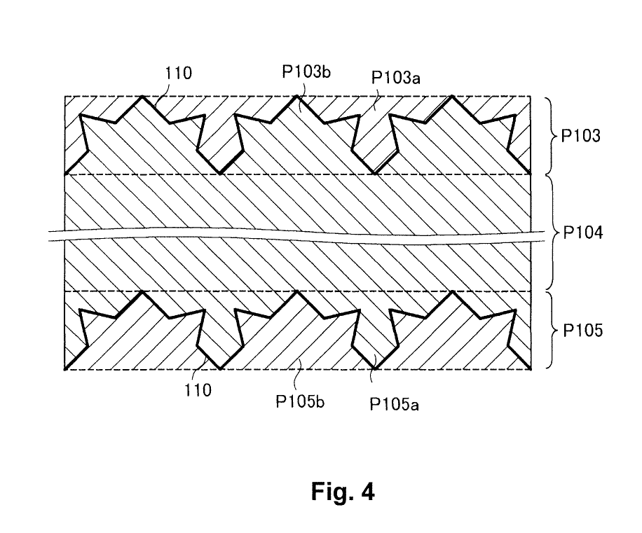

FIG. 4 is a drawing showing an enlarged section of FIG. 3B. In FIG. 4, areas P103 and P105 are printed with partial overlap. The area P103 can be divided by a boundary line 110 into a first partial area 103a that is printed by the downstream nozzles 93, and a second partial area 103b that is printed by the upstream nozzles 91. There is no overlap between the first partial area 103a and the second partial area 103b. Similarly, the area P105 can be divided into a first partial area 105a and a second partial area 105b.

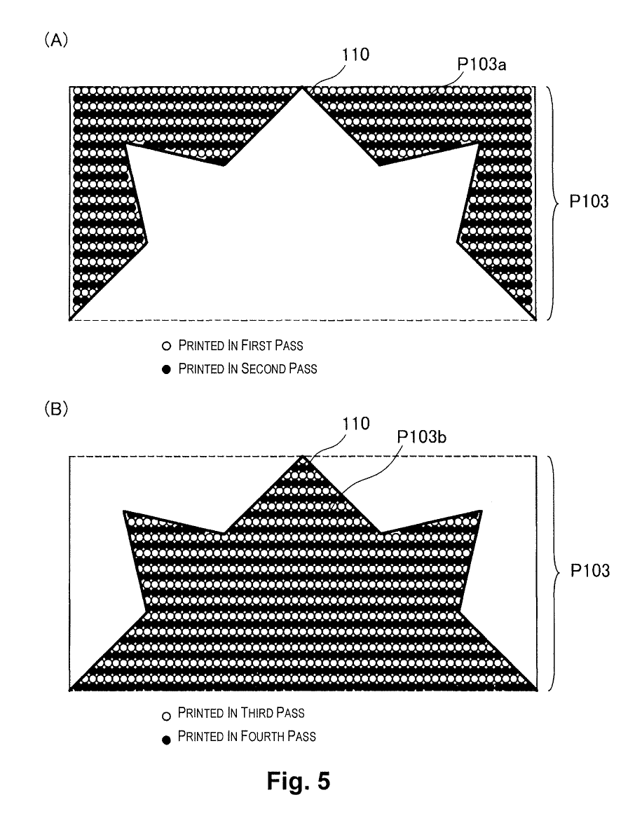

FIG. 5 is a drawing showing pixel rows in a portion printed by upstream nozzles and in a portion printed by downstream nozzles, in the area P103. FIG. 5 (A) shows the partial area 103a that is printed by the downstream nozzles 93, and FIG. 5 (B) shows the partial area 103b that is printed by the upstream nozzles 91. In the area P103, the upper side of the boundary line 110 in the drawing is the partial area 103a that is printed by the downstream nozzles 93, and the lower side thereof in the drawing is the partial area 103b that is printed by the upstream nozzles 91. The areas 103a and 103b are each printed in two passes as described above. In FIGS. 5 (A) and (B), portions printed in odd-numbered (first and third) passes are indicated by white circles (∘), and portions printed in even-numbered (second and fourth) passes are indicated by black circles ().

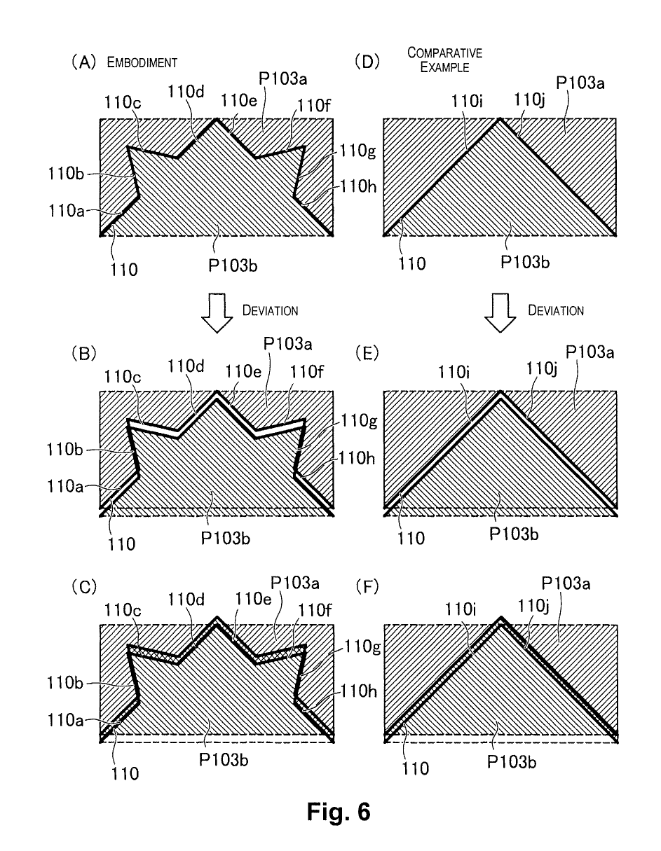

FIG. 6 is a drawing showing instances of deviation of bands in the sub-scanning direction, for a first band and a second band. FIG. 6 (A) to (C) depict the present embodiment, and FIG. 6 (D) to (F) depict a comparative example. According to the present embodiment, the boundary line 110 between the area P103a and the area P103b is composed of line segments 110a to 110h, and forms an approximately star shape. In the comparative example, on the other hand, the boundary line 110 is composed of line segments 110i, 110j, and forms oblique sides of a triangle. FIG. 6 (B) and FIG. 6 (E) depict instances where the second band has deviation relative to the first band in the sub-scanning direction (the downward direction in the drawing). As mentioned previously, movement in the sub-scanning direction is accomplished by the paper feed roller 75. For this reason, deviation may occur if there is a difference in friction between the paper feed roller 75 and the printing medium P. In the comparative example shown in FIG. 6 (E), nonprinted gap portions are produced in portions of the line segments 110i, 110j. In the present embodiment shown in FIG. 6 (B), on the other hand, while gap portions are produced in portions of the line segments 110a, 110c, 110d, 110e, 110f, and 110h, portions of the line segments 110b, 110g are printed overlapping. For example, in a case where the printing medium P has been printed with a single color, in the comparative example, due to their large size the gap portions appear as white streaks in the area P103, or the area P103 appears lighter in comparison with the area P102 or the area P104. In the present embodiment, on the other hand, while gap portions are produced in portions of the line segments 110a, 110c, 110d, 110e, 110f, and 110h, because areas printed with overlap are produced in portions of the line segments 110b, 110g, when viewed from a distance, the gap portions and the overlapping portions cancel out, making it unlikely that the area P103 will appear lighter in comparison with the area P102 or the area P104. Specifically, the area P103 will appear to be substantially identical in color to the area P102 or the area P104.

FIG. 6 (C) and FIG. 6 (F) depict instances of deviation of the second pass relative to the first pass in the sub-scanning direction (the upward direction in the drawing). In the comparative example shown in Figure (F), portions of the line segments 110i, 110je are printed with overlap. Consequently, the area P103 appears darker in comparison with the area P102 or the area P104. In the present embodiment, on the other hand, while portions of the line segments 110a, 110c, 110d, 110e, 110f, and 110h are printed with overlap, gap portions are produced in portions of the line segments 110b, 110g. Specifically, this makes it unlikely that the area P103 will appear to be darker in comparison with the area P102 or the area P104. Specifically, the area P103 will appear to be substantially identical in color to the area P102 or the area P104.

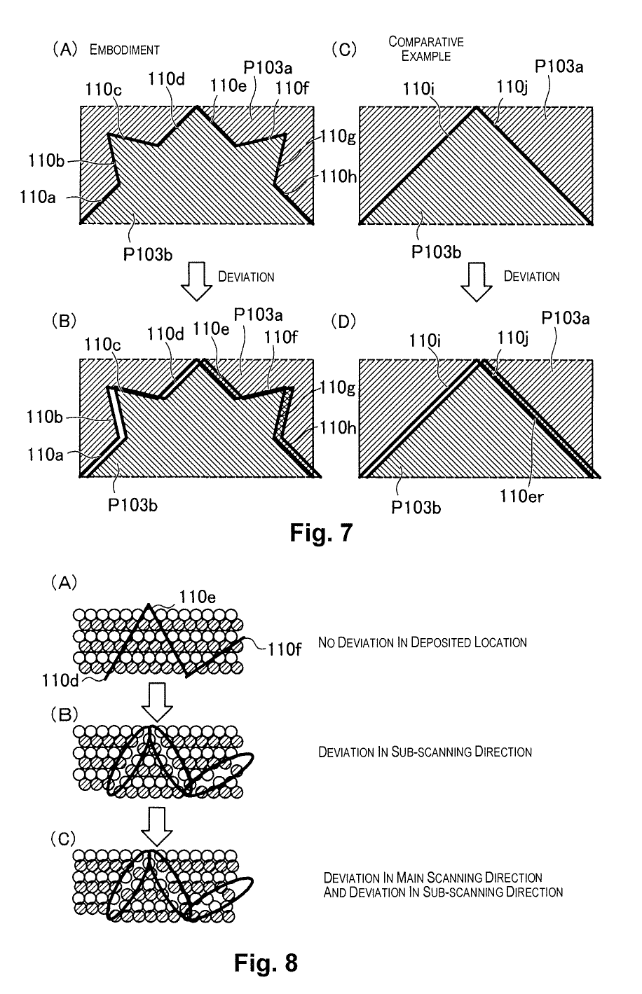

FIG. 7 is a drawing showing instances of deviation of a first band and a second band in the main scanning direction. FIGS. 7 (A) and (C) are identical to FIGS. 6 (A) and (D). FIG. 7 (B) and FIG. 7 (D) depict instances of deviation of the second band relative to the first band in the main scanning direction (the rightward direction in the drawing). In this case, in the comparative example, a nonprinted gap is produced in the portion of the line segment 110el on the left side, whereas the portion of the line segment 110er on the right side is printed with overlap. In the present embodiment, on the other hand, while nonprinted gaps are produced in the portions of the line segments 110a, 110b, 110d, and 110f, the portions of the line segments 110c, 110e, 110g, and 110h are printed with overlap. Comparing the two, in the present embodiment, the nonprinted gap portions and the overlap printed portions appear at shorter periodicity in relation to the main scanning direction. As a result, in the present embodiment, the area P103 tends to appear substantially identical in color to the area P102 or the area P104.

FIG. 8 is a drawing showing enlarged views of the vicinity of the boundary of line segments 110d, 110e. FIG. 8 (A) depicts an instance in which no deviation has occurred; FIG. 8 (B) depicts an instance of deviation of the second band relative to the first band in the sub-scanning direction (the downward direction in the drawing); and FIG. 8 (C) depicts an instance of further deviation of the second pass and the fourth pass in the main scanning direction. As discussed in relation to FIG. 6, in FIG. 8 (B) white streaks are visible upon close examination, although they do not stand out in the partial overlap area overall. In FIG. 8 (C) on the other hand, white streaks are not readily noticeable even upon close examination. In this way, where a single band is printed in multiple passes, it is possible to prevent white streaks from standing out, even in the event of deviation in the main scanning direction in addition to the sub-scanning direction (the downward direction in the drawing).

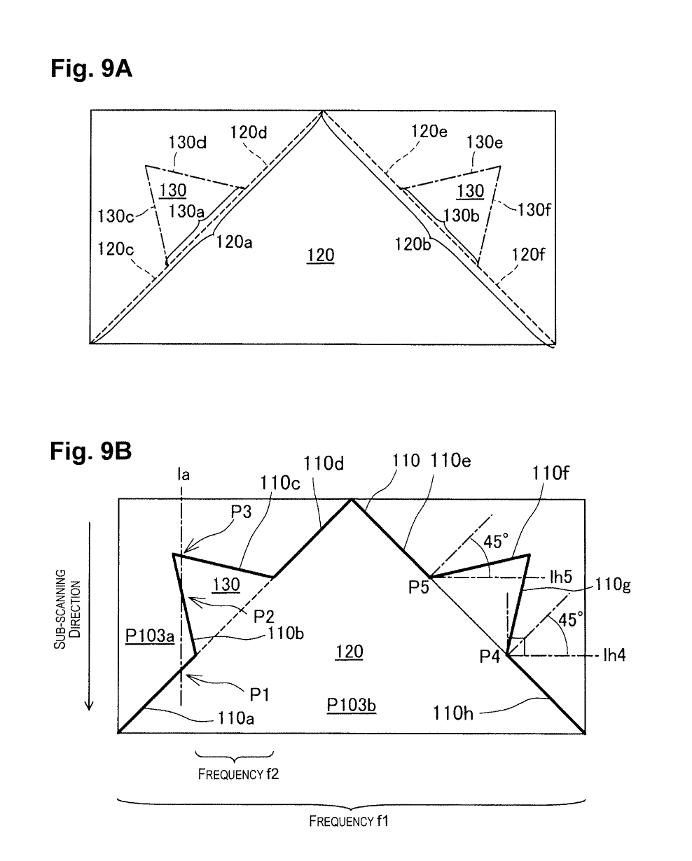

FIGS. 9A and 9B are drawings showing features of a boundary line on a printing medium. FIG. 9A is a simple depiction of a configuration example of a boundary line 110. The base side 130a of a second triangle 130 is positioned on an oblique side 120a of a first triangle 120, and the base side 130b of another second triangle 130 is positioned on an oblique side 120b of the first triangle 120. The boundary line 110 is formed along substantially star shaped contours defined by portions of oblique sides that belong to the two triangles 120, 130 but that do not overlap sides of other triangles 120, 130 (i.e., line segments 120c, 130c, 130d, 120d, 120e, 130e, 130f, and 1200. The line segments 120c, 130c, 130d, 120d, 120e, 130e, 130f, and 120f respectively correspond to the line segments 110a to 110h of the boundary line 110. Or, the boundary line 110 is formed along polygonal contours defined by a combination of a first triangle 120, and second triangles 130 that are smaller than the first triangle 120 and that have as their base side a portion of the oblique side 120a or 120b of the first triangle 120.

FIG. 9B shows features of the boundary line 110. A line la is drawn parallel to the sub-scanning direction on the printing medium P. Of the line segments 100a to 100d that make up the boundary line 110, this parallel line la intersects line segments 110a to 110c at points P1 to P3 respectively. At points P1 and P3, the line la crosses over the boundary line 110 from the second partial area 103b into the first partial area 103a. At point P2, the line la crosses over the boundary line 110 from the first partial area 103b into the second partial area 103b. Thus, the line la has a portion that crosses over the boundary line 110 from the second partial area 103b into the first partial area 103a, and a portion that crosses over the boundary line 110 from the first partial area P 103b into the second partial area P 103b. Owing to this feature of the boundary line 110, in the event of deviation of first band and the second band in the sub-scanning direction during partial overlap printing for example, gaps will open up between the first partial area P 103b and the second partial area P 103b in portions of some of the line segments 100a to 100d, whereas the first partial area P 103b and the second partial area P 103b will overlap in portions of other line segments. For this reason, the first partial area P 103b and the second partial area P 103b neither unilaterally spread apart nor overlap, and therefore noticeable differences in color shade do not readily arise between non-overlap printed areas, for example, the area P102 (FIG. 3B), and the partial overlap area P103. It is not necessary for the line la to have the above feature (i.e., of the line la having a portion that crosses over the boundary line 110 from the second partial area P 103b into the first partial area P 103a, and a portion that crosses over the boundary line 110 from the first partial area P 103b into the second partial area P 103b) over the entire area in the main scanning direction; optionally, only some of the areas need have the above feature.

In the present embodiment, the configuration shown in FIG. 9B is a single unit; on the printing medium P, a plurality of these single units are lined up side by side in the main scanning direction. Specifically, the first and second triangles 120, 130 shown in FIG. 9A or FIG. 9B appear with a given periodicity (frequency). In preferred practice, the frequency f2 of appearance of the second triangles 130 is greater than the frequency f1 of appearance of the first triangles 120. By so doing, it is possible for the second triangles to dispere continuity by the first triangles 120 in the main scanning direction, or in a direction diagonal to the sub-scanning direction. As a result, whereas in the absence of the second triangles 130, the first partial area P103b and the second partial area P103b would either spread apart or overlap along the entire line segment 100e as shown in FIG. 6 (B-2) or (B-3), according to the present embodiment, the first partial area P103b and the second partial area P103b spread apart only in portions of a few of line segments 100a to 100d which are shorter than the line segment 100e, while the first partial area P103b and the second partial area P103b overlap in portions of the other segments, as shown in FIG. 6 (A-2) or (A-3). Consequently, noticeable difference in color shade between the area P102 (FIG. 3B) and the partial overlap printed area P103 may be avoided. The size (amplitude) of the second triangles 130 in the sub-scanning direction is preferably smaller than the size (amplitude) of the first triangles 120 in the sub-scanning direction.

On the boundary line 110, let the boundary of line segments 110a and 110b be denoted as P4, and the boundary of line segments 110c and 110d as P5. A line lh4 orthogonal to the sub-scanning direction is drawn through point P4, and a line lh5 orthogonal to the sub-scanning direction is drawn through point P5. The angle formed by the line lh4 and the line segment 110b may be greater than 45 degrees (π/4) but less than 90 degrees (π/2), whereas the angle formed by the line lh5 and the line segment 110c may be great than 0 degrees but less than 45 degrees. This minimizes the likelihood of streaks appearing in the main scanning direction or sub-scanning direction.

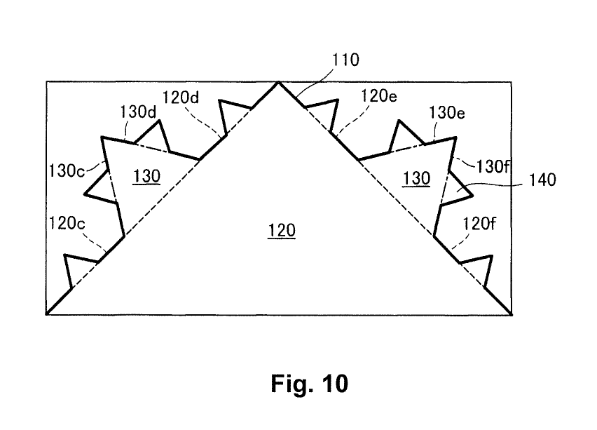

FIG. 10 is a drawing showing a modified example of a boundary line. The boundary line shown in FIG. 10 further includes third triangles 140 which are disposed on the line segments 120c, 130c, 130d, 120d, 120e, 130e, 130f, and 120f of the example shown in FIGS. 9A and 9B; and is formed along substantially star shaped contours defined by portions of oblique sides that belong to the three triangles 120, 130, 140 but that do not overlap sides of other triangles 120, 130, 140. Optionally, even smaller triangles may be added.

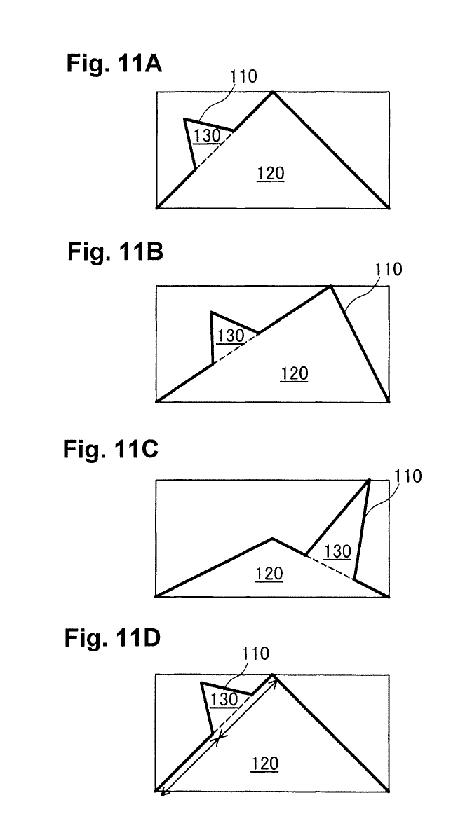

FIGS. 11A to 11D are drawings showing modified examples of boundary lines. In the following modified example, variations of the triangle shapes that define the boundary line 110 are shown. In the preceding embodiment, second triangles 130 are respectively positioned on two oblique sides of the first triangle 130; but may instead be provided on one oblique side only, as shown in FIG. 11A. Provided that a second triangle is present on at least one oblique side of the first triangle 120, it is possible to avoid noticeable difference in color shading between the area P103 that is printed in the second pass and the area P102 or P104 that is printed in the first pass, arising from deviation in the main scanning direction or sub-scanning direction. Optionally, the first triangle 120 is a non-equilateral triangle as shown in FIG. 11B. Even where the first triangle 120 is a non-equilateral triangle, provided that a second triangle is present on an oblique side thereof, it is possible to avoid noticeable difference in color shading between the area P103 that is printed in the second pass and the area P102 or P104 that is printed in the first pass, arising from deviation in the main scanning direction or sub-scanning direction.

As shown in FIG. 11C, the first triangle 120 may be reduced in height, and the height of the second triangle 130 may be increased to one greater than the height of the first triangle. By so doing, it is possible to bring the total surface area of the first and second triangle 120, 130 into substantial equality with the remaining surface area, and to match the number of pixel rows printed in the first pass with the number of pixel rows printed in the second pass. Also, the placement location of the second triangle 130 may be shifted along an oblique side of the first triangle 120 relative to the center part of the oblique side, as shown in FIG. 11D.

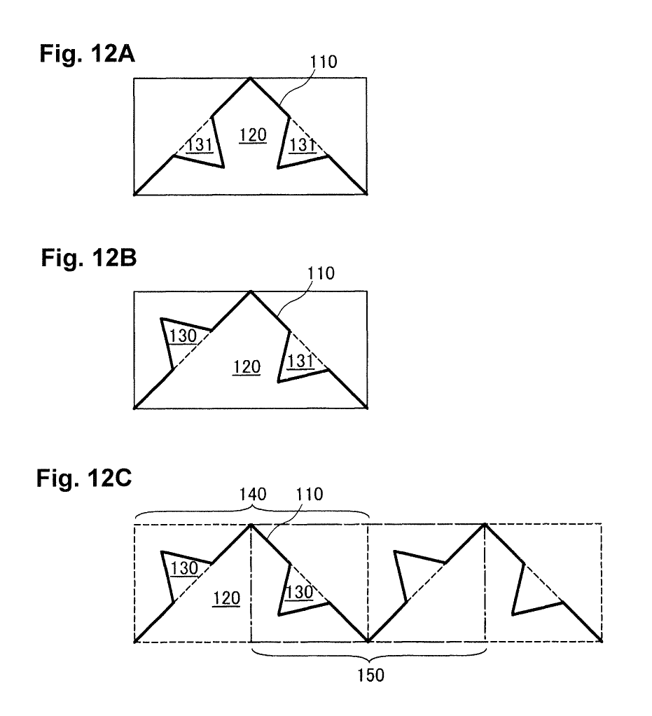

FIGS. 12A to 12C are drawings showing modified examples of boundary lines. In the preceding embodiment and modification examples, the second triangle 130 is added as a protrusion positioned on the first triangle 120, however, in a converse arrangement, a second triangle 131 may be subtracted to create a recess instead of a protrusion. FIG. 12A depicts a second triangle 131 positioned as a recess on the first triangle 120. FIG. 12B depicts the first triangle 120 with a second triangle 130 positioned as a protrusion and with another second triangle 131 as a recess. FIG. 12C shows the pattern of FIG. 12B lined up side by side in the main scanning direction. In this case, two constituent units 140, 150 may be contemplated. Considered in terms of symmetry, these two constituent units 140, 150 are congruous. As a result, it is possible for the areas P103a, P103b to be given equal surface area.

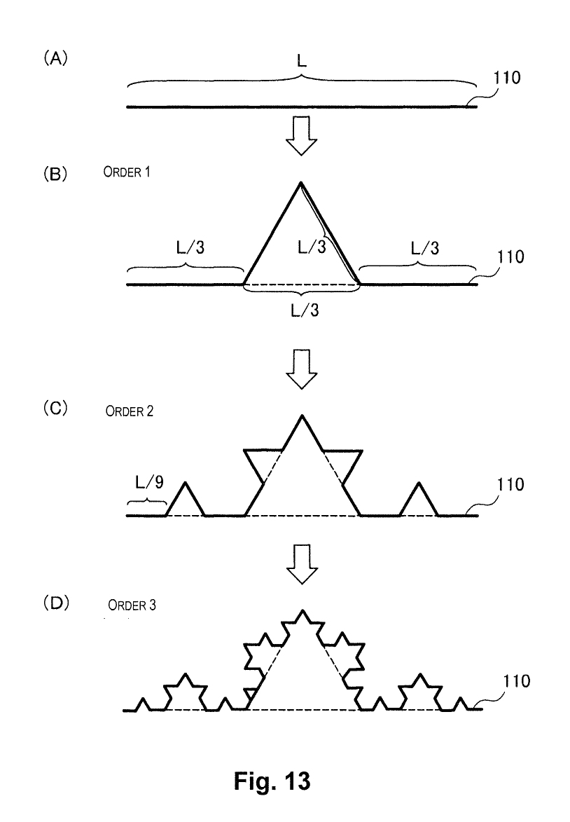

FIG. 13 is a drawing showing an example of an instance of using the Koch curve to form a portion printed by upstream nozzles and a portion printed by downstream nozzles. Optionally, the boundary line 110 may be a Koch curve. The Koch curve is one type of fractal pattern, specifically, a pattern obtained by repeating to infinity a process of dividing a line segment into three equal parts and constructing an equilateral triangle having two of the division points as apices. FIG. 13 (B) shows the result of one iteration of division of a line segment into three equal parts and construction of an equilateral triangle having two of the division points as apices (order 1), FIG. 13 (C) shows the result of two iterations (order 2), and FIG. 13 (D) shows the result of three iterations (order 3). As division of a line segment into three equal parts and construction of an equilateral triangle having two of the division points is repeated to infinity, the length of the line segment becomes infinitely great. If the order is too low, it is difficult to form a boundary line 110 such that in portions of some of the line segments defining the boundary line 110 the first partial area P103b and the second partial area P103b spread apart, whereas in portions of other line segments the first partial area P103b and the second partial area P103b overlap. Higher orders necessitate greater numbers of the upstream nozzles 91 and the plurality of downstream nozzles 93. Consequently, for the purposes of implementation in the present embodiment, it is preferable to use an order of 2 to 4, especially an order of 2 or 3. Other fractal patterns besides the Koch curve, such as the Hilbert curve, may be used for the boundary line 110 as well. Because fractal shapes have self-similarity, it is possible to disperse gaps and overlap between the areas 103a and 103b.

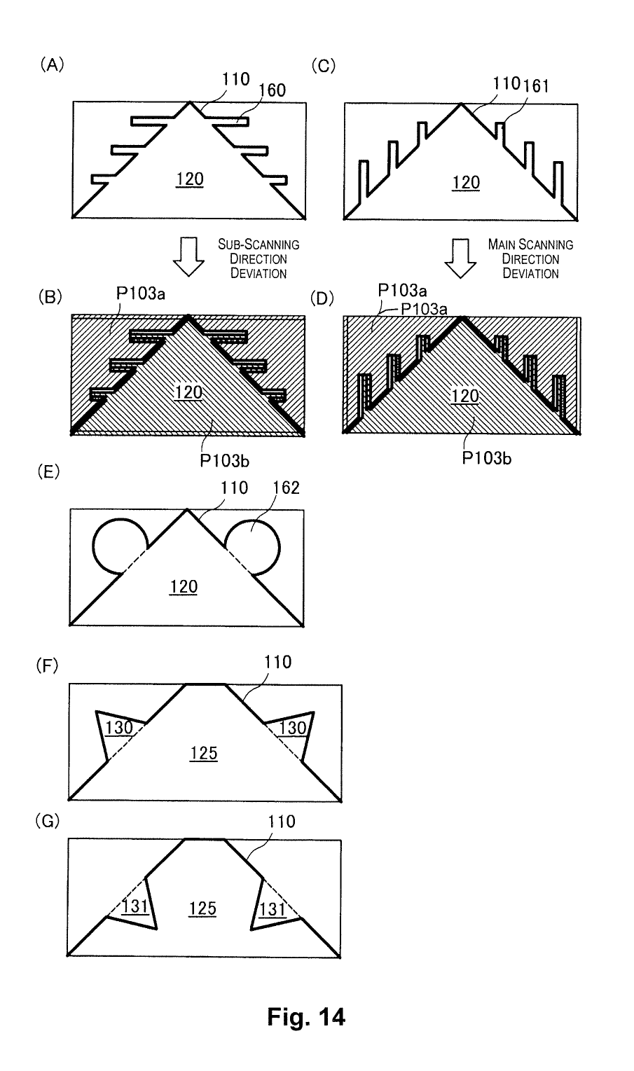

FIG. 14 is a drawing showing other modified examples of boundary lines. Whereas the boundary lines 110 discussed above are all based on combinations of triangle shapes, triangles may be combined with other patterns. The boundary line 110 shown in FIG. 14 (A) has a shape produced by adding bands 160 that are parallel to the main scanning direction to a triangle 120. By so doing, the area P103 and the area P102 or P104 will readily appear to have substantially identical color, even with deviation of the areas P103a and P103b in the sub-scanning direction, as shown in FIG. 14 (B). The boundary line 110 shown in FIG. 14(C) has a shape produced by adding bands 161 that are parallel to the sub-scanning direction to a triangle 120. By so doing, the area P103 and the area P102 or P104 will readily appear to have substantially identical color, even with deviation of the areas P103a and P103b in the main scanning direction, as shown in FIG. 14 (D).

FIG. 14 (E) depicts addition of circles 162 to a triangle 120. Where circles are used, regardless of the direction of deviation of the areas P103a and P103b, some of the portions tangent to the circles will spread apart to form gaps, while others will overlap, and therefore the gaps and overlap tend to cancel out so that the area P103 and the area P102 or P104 appear to have substantially identical color.

FIGS. 14 (F) and (G) depict the use of a trapezoid 125 instead of a triangle 120. FIG. 14 (F) depicts addition of triangles 130 as protrusions on oblique sides of the trapezoid 125, while FIG. 14 (G) depicts subtraction of triangles 131 from oblique sides of the trapezoid 125 to create recesses. With such combinations of a trapezoid 125 with triangles 130 or 131 as well, it is possible for the area P103 and the area P102 or P104 to appear to have substantially identical color.

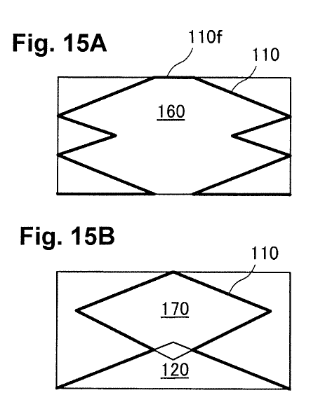

FIGS. 15A and 15B are drawings showing other modified examples of boundary lines. FIG. 15A shows a combination of two squares. FIG. 15B shows a combination of a triangle and a square. The boundary line 110 may have patterns such as these as well.

The boundary lines 110 discussed up to this point are single continuous lines. Here, a single continuous line means a line that could be drawn with a single continuous stroke, without intersection. The boundary line 110 may be continued on using the boundary of the area 102 and the area 103, or the boundary portion of the area 102 and the area 103. For example, in the case of the boundary line 110 shown in FIG. 15A, the line segment 110f is the boundary portion of the area 102 and the area 103, and the line continues on via this portion.

According to the present embodiment, the printer 20 is provided with a plurality of ink cartridges 82 to 87 and has a plurality of nozzle rows. In this instance, different partial overlap masks 200 may be used for different individual colors. Because dispersion can be made to differ for different individual colors, it is possible to increase the likelihood that the area P103 will appear to be the same color as the area P102 or the area P104. Moreover, while the present embodiment describes an example of an inkjet system printer, implementation is possible in non-inkjet system printers, such as laser printers, as well.

According to the present embodiment, the line la that is parallel to the sub-scanning direction has a portion that crosses over the boundary line 110 from the second partial area P103b to the first partial area 103a, and a portion that crosses over the boundary line 110 from the first partial area P103b to the second partial area 103b; however, optionally, a line that is orthogonal to the sub-scanning direction (a line parallel to the main scanning direction) has a portion that crosses over the boundary line 110 from the second partial area P103b to the first partial area 103a, and a portion that crosses over the boundary line 110 from the first partial area P103b to the second partial area 103b. By so doing, it is possible to make the area P103 appear substantially the same color as the area P102 or the area P104, even if deviation arises in the main scanning direction.

In the preceding description, there are described examples of the boundary line 110 being based on straight lines such as triangles or trapezoids, but optionally, the boundary line 110 may be based on curved lines. For example, the boundary line 110 may have a shape that includes a Takagi curve (Blancmange curve), a de Rham curve, or part of a Mandelbrot set shape.

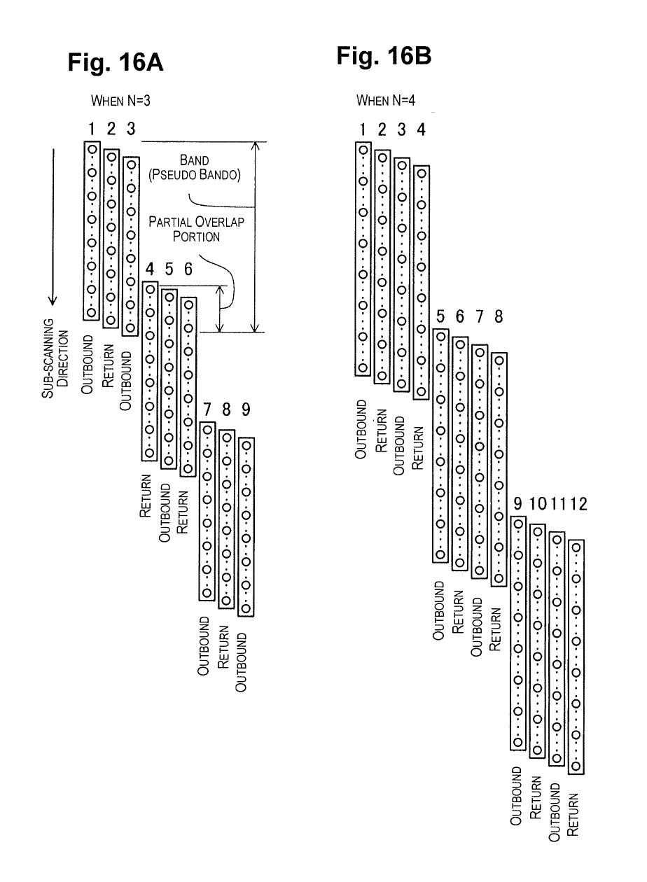

FIGS. 16A and 16B are a drawing showing in model form examples of pseudo band printing. The numbers of nozzles, like those shown in FIG. 3A, are two upstream nozzles 91, four central nozzles 92, and two downstream nozzles 93. In the present embodiment, a single band (a pseudo band) is printed in two passes; however, a single band (a pseudo band) may be printed in a plurality of passes equal to two or more passes, for example, three passes, four passes, . . . , eight passes, and so on. FIG. 16A shows an instance of printing a single band (a pseudo band) in three passes (N=3), and FIG. 16B shows an instance of printing a single band (a pseudo band) in four passes (N=4). In FIGS. 16A and 16B, the white circles (∘) are pixels that are printed in main scanning passes, and dots () are pixels that are not printed in main scanning passes. While not depicted in the drawing, the number of passes N may be 5 or greater.

While the present invention has been shown herein on the basis of certain preferred embodiments, the embodiments herein are intended to aid in understanding of the invention and should not be construed as limiting the invention. Various modifications and improvements are possible without departing from the spirit of the invention as set forth in the appended claims, and these equivalents shall be considered to fall within the scope of the invention.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms. “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. For example, these terms can be construed as including a deviation of at least ±5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A printing device comprising:
a print head having a plurality of nozzles;
a main scanning direction drive mechanism configured and arranged to move the print head and a printing medium relative to each other in a main scanning direction;
a sub-scanning direction drive mechanism configured and arranged to move the print head and the printing medium relative to each other in a sub-scanning direction; and
a control portion configured to execute partial overlap printing whereby the print head and the printing medium are moved relative to each other in the sub-scanning direction in a single main scan pass so that pseudo bands are printed in the course of N (where N is a natural number) main scan passes, and an overlap printed area constituting portions of the pseudo bands is printed in the course of 2N main scanning passes,
the overlap printed area being divided by a single continuous boundary line into a first area that is printed by upstream nozzles among the plurality of nozzles, and a second area that is printed by downstream nozzles among the plurality of nozzles, and
the boundary line including a first boundary line portion where a parallel line extending parallel to the sub-scanning direction crosses over the boundary line from the first area into the second area, and a second boundary line portion where the parallel line crosses over from the second area into the first area.

2. The printing device according to claim 1, wherein
the boundary line has asperities with a low-frequency component and a high-frequency component with respect to the main scanning direction.

3. The printing device according to claim 2, wherein
an amplitude of the high-frequency component of the asperities is smaller than an amplitude of the low-frequency component.

4. The printing device according to claim 1, wherein
the boundary line is formed along a contour of a polygonal shape that is formed by a combination of a first triangle having a base side parallel to the main scanning direction, and a second triangle smaller than the first triangle and having as a base side a portion of an oblique side of the first triangle.

5. The printing device according to claim 4, wherein
one of two oblique sides of the second triangle intersects the main scanning direction at an angle of more than 0 degree and less than 45 degrees, while the other of the two oblique sides intersects the main scanning direction at an angle of more than 45 degrees and less than 90 degrees.

6. The printing device according to claim 1, wherein
the boundary line includes a Koch curve portion or a fractal shape portion.

7. The printing device according to claim 1, wherein
the boundary line includes a portion where a second parallel line extending parallel to the main scanning direction crosses over the boundary line from the first area into the second area, and a second boundary line portion where the second parallel line crosses over from the second area into the first area.

8. A printing device comprising:
a print head having a plurality of nozzles;
a main scanning direction drive mechanism configured and arranged to move the print head and a printing medium relative to each other in a main scanning direction during band printing;
a sub-scanning direction drive mechanism configured and arranged to move the print head and the printing medium relative to each other in a sub-scanning direction; and
a control portion configured to execute partial overlap printing whereby the print head and the printing medium are moved relative to each other in the sub-scanning direction in a single main scan pass so that pseudo bands are printed in the course of N main scan passes (where N is a natural number), and an overlap printed area constituting portions of the pseudo bands is printed in the course of 2N main scanning passes,
the overlap printed area being divided by a single continuous boundary line into a first area that is printed by upstream nozzles among the plurality of nozzles, and a second area that is printed by downstream nozzles among the plurality of nozzles, and
the boundary line including a first boundary line portion where a parallel line extending parallel to the main scanning direction crosses over the boundary line from the first area into the second area, and a second boundary line portion where the parallel line crosses over from the second area into the first area.

9. A printing method comprising:
moving a print head and a printing medium relative to each other in a sub-scanning direction in a single main scan pass so that a first pseudo band is printed in the course of N (where N is a natural number) main scan passes; and
moving the print head and the printing medium relative to each other in the sub-scanning direction in a single main scan pass so that a second pseudo band is printed in the course of N main scan passes so as to partially overlap the first pseudo band to form an overlap printed area;
the overlap printed area being divided by a single continuous boundary line into a first area printed by the first pseudo band, and a second area printed by the second pseudo band, the boundary line including a first boundary line portion where a parallel line extending parallel to the sub-scanning direction crosses over the boundary line from the first area into the second area, and a second boundary line portion where the parallel line crosses over from the second area into the first area.
